(19) United States
(12) Patent Application Publication
(10) Pub. No.: US 2023/0053261 A1
(43) Pub. Date: Feb. 16, 2023

(54) TECHNIQUES FOR FAST DOT-PRODUCT COMPUTATION

(71) Applicant: Huawei Technologies Co., Ltd., Shenzhen (CN)

(72) Inventor: Michael DiBrino, Oakridge, NC (US)

(73) Assignee: Huawei Technologies Co., Ltd., Shenzhen (CN)

(21) Appl. No.: 17/974,066

(22) Filed: Oct. 26, 2022

Related U.S. Application Data
(63) Continuation of application No. PCT/US2020/030610, filed on Apr. 30, 2020.

(51) Int. Cl. G06F 7/544; G06F 7/483

(52) U.S. Cl. CPC G06F 7/5443; G06F 7/483; G06F 2207/4824

(57) ABSTRACT

Techniques are presented to improve the speed of calculating floating-point dot-products, such as in a floating point unit (FPU). Rather than determine the full maximum exponent initially and wait until the full individual shift amounts are calculated to right-shift each mantissa product, each product of exponents is divided into two fields, a high field and a low field. The low field is used as a fine-grained shift amount to right-shift each mantissa product as soon as the mantissa product is ready, while only hi field participates in the maximum exponent calculation. This allows a dot-product computation to be speed up in two ways: Right-shifting of the mantissa product can begin as soon as the mantissa products are calculated, without waiting for the maximum exponent calculation; and calculation of the maximum exponent is sped up because it is calculated only on the high fields of the exponent, not its full-width.

### CLAIM OF PRIORITY

This application is a continuation of PCT Pat. Application No. PCT/US2020/030610, entitled “TECHNIQUES FOR FAST DOT-PRODUCT COMPUTATION”, filed Apr. 30, 2020, the entire contents of which is hereby incorporated by reference.

### FIELD

The following is related generally to the field of microprocessors and, more specifically, to microprocessor based devices for performing floating-point arithmetic.

### BACKGROUND

Computer systems frequently include a floating-point unit, or FPU, often referred to as a math coprocessor. In general-purpose computer architectures, one or more FPUs may be integrated as execution units within the central processing unit. An important category of floating point calculations is for the calculation of dot-products (or inner-products) of vectors, in which a pair of vectors are multiplied component by component and the results then added up to provide a scalar output result. An important application of dot-products is in artificial neural networks. Artificial neural networks are finding increasing usage in artificial intelligence applications and fields such as image and video recognition, recommender systems, image classification, medical image analysis, natural language processing, expert systems, autonomous (self-driving) vehicles, data mining, and many other applications. An artificial neural network is formed of a large number of layers through which an initial input is propagated. At each layer, the input will be a vector of values that is multiplied with a vector of weights as a dot-product to provide an output for the layer. Such artificial neural networks can have very large numbers of layers (network depth) and involve large numbers of dot-products within each of layer (network width), so that propagating an initial input through a network is extremely computationally intensive. When training an artificial neural network (i.e., the process of determining a network’s weight values), a number of iterations are typically required to be repeatedly run through the network to determine accurate weight values. Given the increasing importance of artificial networks, the ability to efficiently compute large numbers of dot-products is of great importance.

When computing a dot-product of floating point vectors, the components of the vectors are individually multiplied and summed. To properly align the accumulated sum of the dot product, the maximum exponent of the individual products needs to be determined, as each mantissa dot-product must be right-shifted by the difference between the maximum exponent and each dot-product’s exponent. This process can be quite time consuming, requiring several processing cycles and slowing down the dot-product computation. Given the extremely large numbers of dot-product computations involved in both the training and inferencing phases for artificial neural networks, the ability to more rapidly compute dot-products is of increasing importance.

### SUMMARY

According to one aspect of the present disclosure, a microprocessor includes a plurality of input registers each configured to hold a floating-point N-vector having N components, each of the components having a mantissa value and a corresponding exponent value of M bits, where M and N are integers greater than one; and a floating-point unit connected to the input registers and configured to compute a dot-product of a first floating-point N-vector and a second floating-point N-vector received from the input registers. The floating-point unit includes an exponent determination path configured to determine an exponent value for the dot-product and a mantissa determination path connected to the exponent determination path and configured to determine a mantissa value for the dot-product. The exponent determination path includes: a first adder configured to add the exponent value of the first N-vector and the second N-vector to determine an M bit product value of exponents for each of the N components; comparison logic configured to determine a maximum exponent value from the N product values of the exponents based on a plurality of most significant bits of the corresponding product value of exponents, the plurality of most significant bits being less than M bits; and a second adder configured to determine an exponent value for the dot-product from the maximum exponent value. The mantissa determination path connected includes: a multiplier configured to multiply the mantissa values of the first N-vector and the second N-vector to determine a product value of the mantissas for each of the N components; a right shifter configured to right shift each of the N product values of the mantissas by an amount based on a plurality of least significant bits of the corresponding product value of exponents, the plurality of least significant bits being less than M bits; and a summing circuit configured to sum the right shifted N product values of the mantissas to determine a mantissa value for the dot-product.

Optionally, in the preceding aspect, the exponent determination path further includes a decoder configured to decode the plurality of most significant bits of the corresponding product value of exponents.

Optionally, in the preceding aspect, the mantissa determination path is further configured to adjust the right shifted N product values of the mantissas based on the decoded plurality of most significant bits of the corresponding product value of exponents prior to summing the right shifted N product values of the mantissas.

Optionally, in the preceding two aspects, the exponent determination path further includes an overflow/underflow detector connected between the first adder and the comparison logic and configured to determine whether each M bit product value of exponents is an overflow/underflow value.

Optionally, in the any of the preceding aspects, the exponent values of the first N-vector and the second N-vector include a bias and, in determining the M bit product value of exponents, the first adder is configured to subtract off the bias value when adding , for each of the N components, the exponent value of the first N-vector and the second N-vector.

Optionally, in the any of the preceding aspects, the second adder is configured to receive a correction factor from the mantissa determination path for use in determining the exponent value for the dot-product.

Optionally, in the any of the preceding aspects, the summing circuit comprises a sequence of a plurality of stages each including one or more adders.

Optionally, in the preceding aspect, the exponent determination path further includes an intermediate exponent register connected between the comparison logic and the second adder and configured to store the maximum exponent value, and the mantissa determination path further includes an intermediate mantissa register connected between stages of the summing circuit configured to store an intermediate mantissa value.

Optionally, in the any of the preceding aspects, the plurality of most significant bits are the K most significant bits and the plurality of least significant bits are the (M-K) least significant bits.

Optionally, in the any of the preceding aspects, the first floating-point N-vector is an input vector of a layer of a neural network, the second floating-point N-vector is a weight vector of the layer of the neural network, and the dot-product is an output for the layer of the neural network.

Optionally, in the preceding aspect, the input vector of the layer of the neural network is an output of a preceding layer of the neural network.

Optionally, in the any of the two preceding aspects, the output for the layer of the neural network is an input of a subsequent layer of the neural network.

According to an additional aspect of the present disclosure, there is provided a method of calculating a floating-point dot-product performed by a processor. The method includes receiving a first floating-point N-vector having N components at a floating-point unit (FPU) processor, each of the N components thereof having a mantissa value and a corresponding exponent value of M bits, where M and N are integers greater than one; receiving a second floating-point N-vector having N components at the FPU, each of the N components thereof having a mantissa value and a corresponding exponent value of M bits; storing at least one of the first and second floating-point N-vectors in one of a memory or a register; and determining, by the FPU, the floating-point dot-product of the first floating-point N-vector and the second floating-point N-vector. Determining the floating-point dot-product of the first floating-point N-vector and the second floating-point N-vector includes: adding the exponent value of the first N-vector and the second N-vector to determine an M bit product value of exponents for each of the N components; multiplying the mantissas of the first N-vector and the second N-vector to determine a product value of the mantissas for each of the N components; right shifting each of the N product values of the mantissas by an amount based on a plurality of least significant bits of the corresponding product value of exponents, the plurality of least significant bits being less than M bits; determining a maximum exponent value from the N product values of the exponents based on a plurality of most significant bits of the corresponding product value of exponents, the plurality of most significant bits being less than M bits; summing the right shifted N product values of the mantissas to determine a mantissa value for the dot-product; and determining an exponent value for the dot-product from the maximum exponent value.

Optionally, in the preceding aspect of a method of calculating a floating-point dot-product, determining the maximum exponent value includes decoding the plurality of most significant bits of the corresponding product value of exponents.

Optionally, in the preceding aspect of a method of calculating a floating-point dot-product, the method further includes adjusting the right shifted N product values of the mantissas based on the decoded plurality of most significant bits of the corresponding product value of exponents prior to summing the right shifted N product values of the mantissas.

Optionally, in any of the preceding two aspects of a method of calculating a floating-point dot-product, the method further includes determining whether each of the M bit product value of exponents is an overflow/underflow value.

Optionally, in any of the preceding three aspects of a method of calculating a floating-point dot-product, the exponent values of each of the first N-vector and the second N-vector include a bias, and determining the M bit product value of exponents includes subtracting off the bias value when adding , for each of the N components, the exponent value of the first N-vector and the second N-vector.

Optionally, in any of the preceding four aspects of a method of calculating a floating-point dot-product, determining the exponent value for the dot-product includes receiving a correction factor from summing the right shifted N product values of the mantissas.

Optionally, in any of the preceding five aspects of a method of calculating a floating-point dot-product, the plurality of most significant bits are the K most significant bits and the plurality of least significant bits are the (M-K) least significant bits.

Optionally, in any of the preceding aspects of a method of calculating a floating-point dot-product, the first floating-point N-vector is an input vector of a layer of a neural network, the second floating-point N-vector is a weight vector of the layer of the neural network, and the dot-product is an output for the layer of the neural network.

Optionally, in the preceding aspect of a method of calculating a floating-point dot-product, the input vector of the layer of the neural network is an output of a preceding layer of the neural network.

Optionally, in any of the preceding two aspects of a method of calculating a floating-point dot-product, the output for the layer of the neural network is an input of a subsequent layer of the neural network.

Optionally, in any of the preceding aspects of a method of calculating a floating-point dot-product, the method further includes storing at least one of the exponent value for the dot-product and a mantissa value for the dot-product in an output register.

Optionally, in any of the preceding aspects of a method of calculating a floating-point dot-product, determining the floating-point dot-product of the first floating-point N-vector and the second floating-point N-vector further comprises: subsequent to right shifting each of the N product values of the mantissas and prior to determining the mantissa value for the dot-product, storing an intermediate result of the mantissa value for the dot-product in an intermediate register for the mantissa value for the dot-product; and subsequent to determining a maximum exponent value from the N product values of the exponents and prior to determining an exponent value for the dot-product, storing an intermediate value for the exponent value for the dot-product in an intermediate register for the exponent value for the dot-product.

According to a further aspect, a microprocessor includes: a first input register configured to hold a first floating-point N-vector having N components each having a mantissa value and a corresponding M-bit exponent value, where M and N are integers greater than one; a second input register configured to hold a second floating-point N-vector having N components each having a mantissa value and a corresponding M-bit exponent value; and a floating-point unit connected to the first and second input registers and configured to compute a dot-product of the first floating-point N-vector and the second floating-point N-vector. The floating-point unit comprises: a set of intermediate registers configured to store an intermediate computation of an M bit exponent value of the dot-product and an intermediate computation of a mantissa value of the dot-product; a first computational section configured to receive the first floating-point N-vector and second floating-point N-vector and compute and store the intermediate computation of the mantissa value and the intermediate computation of the exponent value for the dot-product in the intermediate set of registers in a first computational cycle; and a second computational section. The first computational section includes: a plurality of N multipliers each configured to determine a product of the mantissa values of corresponding components of the first N-vector and the second N-vector; a plurality of N first adders each configured to bit-wise add exponents of the components of the exponent values of corresponding components of the first N-vector and the second N-vector, logic circuitry configured to determine the intermediate computation of the exponent value from the K most significant bits of the components of the exponent values of the first N-vector and the second N-vector; and a plurality of N right shifter configured to determine the intermediate computation of the mantissa value by right shifting the product of the mantissa values of the corresponding components of the first N-vector and the second N-vector based on the (M-K) least significant bits of the components of the exponent values of the first N-vector and the second N-vector. The second computational section is configured to receive the intermediate computation of the mantissa value and the intermediate computation of the exponent value and determine a final exponent value of the dot-product and a final mantissa value of the dot-product in a second computational cycle.

Optionally, in the preceding aspect, the first computational section further comprises a first partial sum circuit configured to receive and partially sum the right shifted products of the mantissa values of the corresponding components of the first N-vector and the second N-vector to thereby determine the intermediate computation of the mantissa value, and the second computational section further comprises: a second partial sum circuit configured to receive the intermediate computation of the mantissa value and determine therefrom the final mantissa value of the dot-product; and a second adder configured to receive the intermediate computation of the exponent value and determine therefrom the final exponent value of the dot-product.

Optionally, in the preceding aspect, the first partial sum circuit comprises a sequence of a plurality of stages each including one or more adders and wherein the second partial sum circuit comprises a sequence of a plurality of stages each including one or more adders.

Optionally, in any of the preceding two aspects, the second adder is configured to receive a correction factor from the second partial sum circuit for use in determining the exponent value for the dot-product.

Optionally, in any of the preceding four aspects, the first computational section further comprises a plurality of N decoders each configured to decode the K most significant bits of the corresponding added exponents.

Optionally, in the preceding aspect, the first computational is further configured to adjust the shifted product of the mantissa values of the first N-vector and the second N-vector based on the decoded plurality of most significant bits of the corresponding product value of exponents prior to summing the right shifted product values of the mantissas.

Optionally, in any of the preceding six aspects, the first computational section further comprises: a plurality of N overflow/underflow detectors each connected between the corresponding first adder and the logic circuitry and configured to determine the intermediate computation of the exponent value, each of the overflow/underflow detectors configured to determine whether bit-wise added exponents of the components of the exponent values of the corresponding components of the first N-vector and the second N-vector are overflow/underflow values.

Optionally, in any of the preceding seven aspects, the exponent values of the first N-vector and the second N-vector include a bias and, in determining the M bit product value of exponents, the first adder is further configured to subtract off the bias value when adding , for each of the N components, the exponent value of the first N-vector and the second N-vector.

Optionally, in any of the preceding eight aspects, the first floating-point N-vector is an input vector of a layer of a neural network, the second floating-point N-vector is a weight vector of the layer of the neural network, and the dot-product is an output for the layer of the neural network.

Optionally, in the preceding aspect, the input vector of the layer of the neural network is an output of a preceding layer of the neural network.

Optionally, in any of the preceding two aspects, wherein the output for the layer of the neural network is an input of a subsequent layer of the neural network.

According to other aspects, a microprocessor includes first and second input registers respectively configured to hold a first floating-point vector and a second floating-point vector, each of the first and second floating point vectors having N components each having a mantissa value and a corresponding M-bit exponent value, where M and N are integers greater than one. The microprocessor also includes a set of intermediate registers configured to store an intermediate M bit exponent value and an intermediate mantissa value of a dot-product of the first floating point vector and the second floating point vector. Means are provided for computing in a first computation cycle the intermediate exponent value from the K most significant bits of the components of the exponent values of the first vector and the second vector, where K is less than M. Means are provided for computing in the first computation cycle the intermediate mantissa value by right shifting the product of the mantissa values of the corresponding components of the first vector and the second vector based on the (M-K) least significant bits of the components of the exponent values of the first vector and the second vector. Means are also provided for determining in a second computational cycle a final exponent value and a final mantissa value of the dot-product of the first floating point vector and the second floating point vector from the intermediate exponent value and intermediate mantissa value stored in the set of intermediate registers.

In the preceding aspects, the means for computing the intermediate exponent value further computes the intermediate exponent value by performing a bit-wise addition of the exponents of the components of the exponent values of corresponding components of the first vector and the second vector.

In either of the preceding two aspects, the means for computing the intermediate mantissa value further computes the intermediate mantissa value by determining a product of the mantissa values of corresponding components of the first vector and the second vector.

In any of the preceding three aspects, the first floating point vector is an input for a layer of a neural network; the second floating point vector is a weight for the layer of the neural network; and the final exponent value and the final mantissa value is an output value for the layer of the neural network.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate elements.

FIGS. 1A and 1B are respectively block diagrams of a computer system and a microprocessor that can be incorporated into such a computer system.

FIG. 2 is a schematic representation of the dot product of an input vector with a weight vector for a layer of neural network.

FIG. 3 is a block diagram illustrating an example of a prior art implementation for the computation of a dot-product of 16 components vectors.

FIG. 4 is a high-level block diagram illustrating the acceleration of the dot-product computation by spitting the product of exponents into a high portion and a low portion.

FIG. 5 is a more detailed representation of one embodiment for the data flow paths, but still in a high-level block diagram representation.

FIG. 6 provides more detail on the upper left quadrant of FIG. 5.

FIGS. 7 and 10 provide more detail on the upper right quadrant of FIG. 5.

FIGS. 8 and 9 illustrate two “edge” cases which define the maximum dataflow adder width.

FIG. 11 provides more detail on the lower left quadrant of FIG. 5.

FIG. 12 provides more detail on the lower right quadrant of FIG. 5.

FIG. 13 is a flowchart of one embodiment for calculation a floating-point dot-product performed by a processor using the architecture described above with respect to FIGS. 4-12.

FIG. 14 is a high-level block diagram of a computing system that can be used to implement various embodiments of a microprocessor as presented in FIGS. 4-12.

### DETAILED DESCRIPTION

The following presents techniques to improve the speed of calculating floating-point dot-products, such as in a central processing unit (CPU), graphic processing unit (GPU), an artificial intelligence (Al) accelerator, or other digital logic that calculates dot-products of floating-point vectors of N components, or “N-vectors”. In order to more rapidly perform floating-point dot-product calculations, rather than determine the full maximum exponent (MaxExp) initially, the embodiments described below do not wait until the full individual shift amounts are calculated (which are dependent upon calculating MaxExp) to right-shift each mantissa product. Instead, each product of exponentials (ProductExpᵢ) is divided into two fields, ProductExpHiᵢ and ProductExpLoᵢ. ProductExpLoᵢ is used as a fine-grained shift amount to right-shift each mantissa product as soon as the mantissa product is ready, while only ProductExpHiᵢ participates in the MaxExp calculation. This allows a dot-product calculation to be sped up in two ways: Right-shifting of the mantissa product can begin as soon as the mantissa products are calculated, without the waiting for calculation of MaxExp and the “dead” latency such waiting would introduce; and calculation of MaxExp is sped up because MaxExp is calculated only on ProductExpHiᵢ, not the full-width ProductExp.

It is understood that the present embodiments of the disclosure may be implemented in many different forms and that claims scopes should not be construed as being limited to the embodiments set forth herein. Rather, these embodiments are provided so that this disclosure will be thorough and complete and will fully convey the inventive embodiment concepts to those skilled in the art. Indeed, the disclosure is intended to cover alternatives, modifications and equivalents of these embodiments, which are included within the scope and spirit of the disclosure as defined by the appended claims. Furthermore, in the following detailed description of the present embodiments of the disclosure, numerous specific details are set forth in order to provide a thorough understanding. However, it will be clear to those of ordinary skill in the art that the present embodiments of the disclosure may be practiced without such specific details.

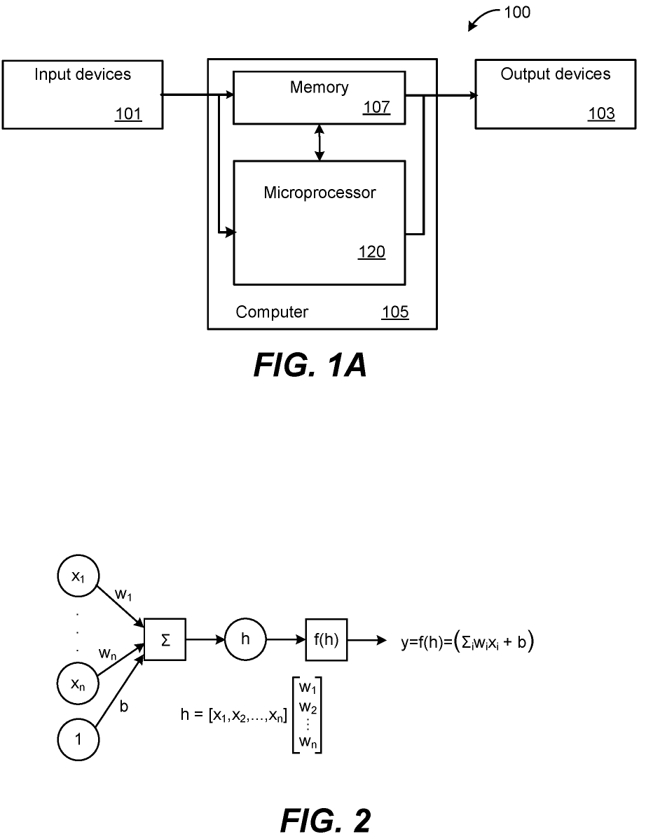

FIGS. 1A and 1B are respectively block diagrams of a computer system and a microprocessor such as can be incorporated into such a computer system. In the simplified representation of FIG. 1A, the computer system 100 includes a computer 105, one or more input devices 101 and one or more output devices 103. Common examples of input devices 101 include a keyboard or mouse. Common examples of output devices 103 include monitors or printers. The computer 105 includes memory 107 and microprocessor 120, where in this simplified representation the memory 107 is represented as a single block. The memory 107 can include ROM memory, RAM memory and non-volatile memory and, depending on the embodiment, include separate memory for data and instructions.

FIG. 1B illustrates one embodiment for the microprocessor 120 of FIG. 1A and also includes the memory 107. In the representation of FIG. 1B, the microprocessor 120 includes control logic 125, a processing section 140, an input interface 121, and an output interface 123. The dashed lines represent control signals exchanged between the control logic 125 and the other elements of the microprocessor 120 and the memory 107. The solid lines represent the flow of data and instructions within the microprocessor 120 and between the microprocessor 120 and memory 107.

The processing block 140 includes combinatorial logic 143 that is configured to execute instructions and registers 141 in which the combinatorial logic stores instructions and data while executing these instructions. In the simplified representation of FIG. 1B, specific elements or units, such as an arithmetic logic unit (ALU) 147, floating-point unit (FPU) processor 147, and other specific elements commonly used in executing instructions are not explicitly shown in the combinatorial logic 143 block. The combinatorial logic 143 is connected to the memory 107 to receive and execute instruction and supply back the results. The combinatorial logic 143 is also connected to the input interface 121 to receive input from input devices 101 or other sources and to the output interface 123 to provide output to output devices 103 or other destinations.

The following considers the calculation of floating-point dot-products, such as in the FPU 147 of FIG. 1B. More generally, the techniques presented can more generally be applied to embodiments for central processing units (CPUs), graphic processing units (GPUs), an artificial intelligence (Al) accelerators, Tensor Processing Units (TPUs), or other digital logic that calculates floating-point dot-products.

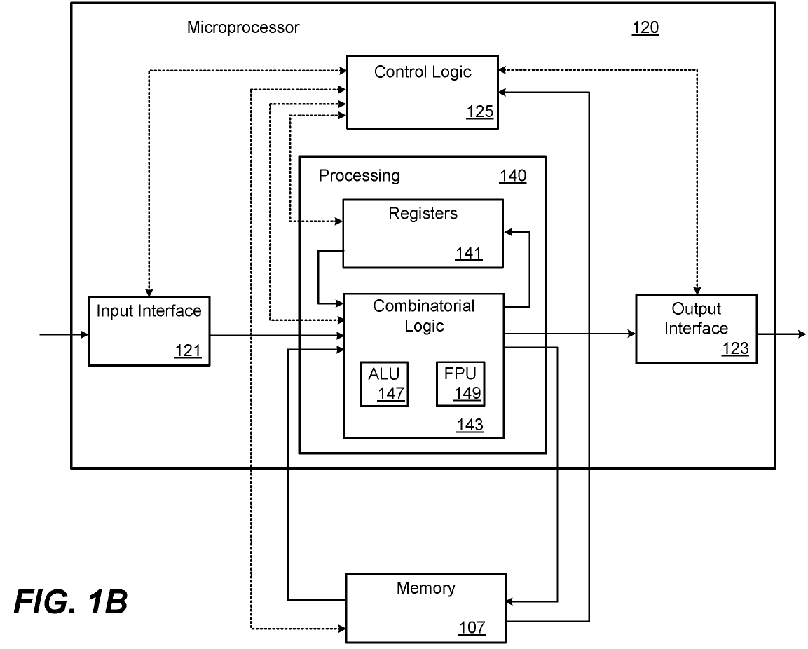

The dot product is a basic computation of linear algebra and is commonly used in deep learning and machine learning. In a single layer of a basic neural network, each neuron takes a result of a dot product as input, then uses its preset threshold to determine the output. Artificial neural networks are finding increasing usage in artificial intelligence applications and fields such as image and video recognition, recommender systems, image classification, medical image analysis, natural language processing, expert systems, autonomous (self-driving) vehicles, data mining, and many other applications. An artificial neural network is formed of a large number of layers through which an initial input is propagated. At each layer, the input will be a vector of values that is multiplied with a vector of weights as a dot-product to provide an output for the layer. Such artificial neural networks can have very large numbers of layers (network depth) and involve large numbers of dot-products within each of layer (network width), so that propagating an input through a network is extremely computationally intensive. In the training of an artificial neural network (i.e., the process of determining a network’s weight values), a number of inputs are typically required to be repeatedly ran through the network to determine accurate weight values. Given the increasing importance of artificial networks, the ability to efficiently compute large numbers of dot-products is of great importance. The application of the dot, or inner, product to a neural network is illustrated schematically in FIG. 2.

FIG. 2 is a schematic representation of the dot product of an input vector with a weight vector for a layer of neural network, where both of the input vector and the weight vector floating point N-vectors (e.g., vectors with N components, each of which are floating point). As noted in the Background, the dot-, or inner-, product is a basic computation in artificial neural networks, with each layer of a network usually requiring a large (sometimes very large) number of dot-product computation between a layer’s inputs and its weights for each layer. As neural networks can be quite “deep” (having very large number of layers), the number of dot-product needed to propagate an initial input, such as an image, through all of the layers of a network to generate the final output of the network can extremely large.

In a layer of neural network, such as convolution layer or a fully connected layer, an input vector [x₁, x₂, ..., x_{n]}, which could be from a previous layer, is multiplied component by component with a weight vector [w₁, w₂, ..., wₙ] and the results are added in a multiply and accumulate operation to find the inner product h, with the output (such as an activation) a function of this inner product:

$$\text{y=f} \left(\text{h}\right) \text{=f} \left({Σ}_{\text{i}} {\text{w}}_{\text{i}} {\text{x}}_{\text{i}} \text{+} \text{b}\right) ,$$

where the result also can also include the input independent bias element b. Powerful neural networks can be created by stacking neurons into multiple layers, but the use of many layers and the large amounts of data involved can make neural networks very computationally intensive and time consuming. More generally, floating-point dot-product computation can be used in machine learning, GPU matrix multiplication, and other applications, as well as for neural networks. Although described here in the context of a dot-product of two vectors, the techniques also extend other multiply and accumulation operations, whether for multiple scalars, vectors, or higher dimensional tensors, such as would be computed in a Tensor Processing Unit (TPU). For example, a TPU computes dot- or inner-products where a vector is a one-dimensional tensor, a two-dimensional tensor is a matrix of values, a three-dimensional tensor is a matrix of matrices, and so on. An example of such matrix multiplications occurs in the convolutional layers of neural networks, where the weight values can be matrices rather than just vectors.

The following presents techniques to calculate a floating-point dot-product with minimum latency. Given the extremely large numbers of dot-product computations involved in both the training and inferencing phases for artificial neural networks, the ability to more rapidly compute dot-products is of importance, with each a cycle that can be saved for a given dot-product computation providing a significant acceleration of the training and inference operations. If an n component vector A has components [aᵢ], i=1-n, and an n component vector B has components [bᵢ], i=1-n, then the dot-, or inner-, product of these two vectors is:

$$\text{A} ⋅ \text{B=} \sum {}_{k = 1}^{n} {\text{a}}_{\text{i}} {\text{b}}_{\text{i}} {\text{= a}}_{\text{1}} {\text{b}}_{\text{1}} \text{+} {\text{a}}_{\text{2}} {\text{b}}_{\text{2}} \text{+ …} \text{+} {\text{a}}_{\text{n}} {\text{b}}_{\text{n}} .$$

The specific example described here is a 16-vector floating-point dot-product (dp16) embodiment, but the technique can be applied more generally. More specifically, for vectors A and B with respective components aᵢ and bᵢ the embodiments described below calculate a dp16 dot-product of the form:

$$\text{Acc} \text{=} {\text{a}}_{0} {\text{b}}_{0} + {\text{a}}_{1} {\text{b}}_{1} + … {\text{a}}_{2} {\text{b}}_{2} + … + {\text{a}}_{\text{n-1}} {\text{b}}_{\text{n-1}} + \text{Acc} \text{,}$$

where the sum over i of aᵢbᵢ is the dot product, n=16; Acc represents an accumulated value; and the Acc to the right of the equal sign can be the value of a previous accumulation operation. For example, if the vectors A and B have more than 16 components, the dot-product can be broken up into sub-products of 16 or fewer components and the multiply and accumulation done for the sub-products, which are then added together. In other examples, where an inputs is applied to weights for multiple nodes of a layer of a neural network, the Acc value on the right can be the value for one or more other nodes of the layer involved in a multiply and accumulate operation to determine an output of the layer.

A problem in calculating a floating-point dp16 dot-product in minimum latency is that the maximum exponent of the dp16 vectors must be found first, and then the vector products must be right-shifted by the difference between the maximum exponent and each vector product exponent:

$${\text{ProductExp}}_{\text{i}} = \text{Exp} \left({\text{a}}_{\text{i}}\right) + \text{Exp} \left({\text{b}}_{\text{i}}\right) - \text{Bias} \text{;}$$

$$\text{MaxExp} \text{=} \text{Max} \left({\text{ProductExp}}_{0} , {\text{ProductExp}}_{1} , … , {\text{ProductExp}}_{\text{n-1}}\right) ;$$

$${\text{ShiftAmt}}_{\text{i}} = {\text{MaxExp - ProductExp}}_{\text{i} .}$$

Finding MaxExp involves a 17-way comparison of the 16 dp16 product components and the Acc vector. In equation 2, the (- Bias) term arises as the exponents are expressed relative to an offset, or bias, so that when two exponents are added there will be twice the bias value and one of these needs to be subtracted off. While this can be accomplished with a tree of 2-way comparisons in logₙ time, the delay is still substantial and can be longer than the time required to calculate the mantissa product of each of the dp16 components. This following presents a faster method of calculating the dp16 sum.

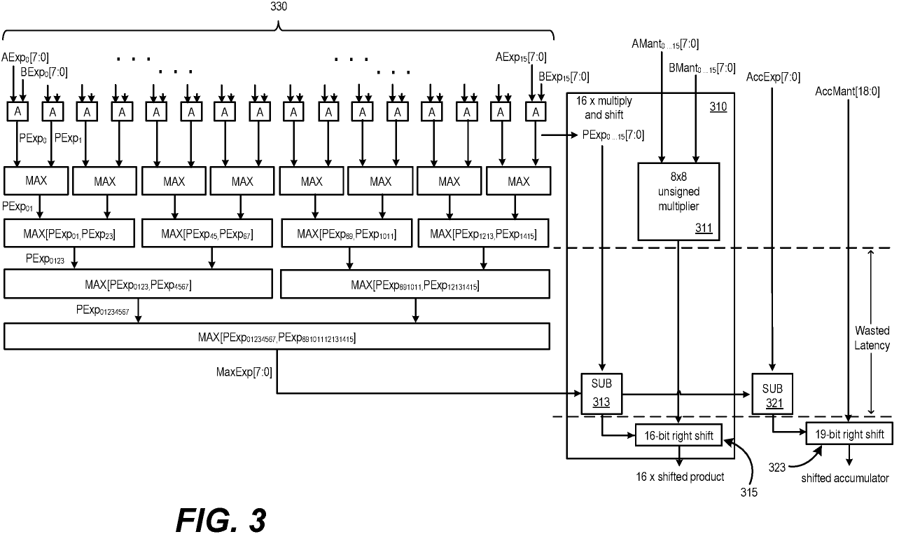

FIG. 3 is a block diagram illustrating an example of an implementation for the computation of a dot-product of 16 components vectors that uses such a tree of 2-way comparisons. In the FIG. 3 example, the A and B vectors are in a BFloat16 format where a vector is expresses as 1 sign bit, 8 exponent bits, and 8 significand bits. As presented in the figure, the right side of FIG. 3 handles the multiplication of the mantissas and the maximum exponent is determined to the left. The mantissa side includes a multiply and shift block 310 for each of the 16 components of A and B, each performing a component wise multiplication in the corresponding 8x8 unsigned multiplier 311 in single cycle. A subtractor 313 receives PExp₀... ₁₅[7:0] and MaxExp[7:0] from the MaxExp side, whose output then goes to the16-bit right shift 315 to provide the 16X shifted product. For the input accumulated value, subtractor 321 receives the exponent AccExp[7:0] and MaxExp[7:0], and provides its output the 19-bit right shift 323, which also receives the mantissa AccMant[18:0] to provide the shifted accumulator value.

Although the 8x8 unsigned multipliers 311 can provide their output in single cycle, the subtractors 313 and 321 need to wait on MaxExp[7:0], which can result in a wasted latency, which, even at one wasted cycle can be significant when large numbers of such calculations are being performed. An exponent determination tree 330 that computes the MaxExp[7:0] value from the 16 exponent values of the A and B vectors. For each component, the A and B exponent values are input into a CPA Carry-Propagate Adder (CPA) at block A on the top row of the tree 330. For example, as shown at top left AExp₀[7:0] and BExp₀[7:0] are input into the left-most CSA, and so on until the inputs of AExp₁₅[7:0] and BExp₁₅[7:0]. The output of each CSA A is the product of exponents obtained by their addition, such as PExp₀[7:0] for AExp₀[7:0] and BExp₀[7:0], where only the values for the first two products (PExp₀[7:0] and PExp₁[7:0]) are explicitly shown. The pair-wise comparisons are then performed to determine the maximum one of these exponents, MaxExp[7:0], Only the outputs along the far-left path are shown to simplify the figure. A first comparison at the first row of boxes MAX gives PExp₀₁[7:0]=Max[PExp₀, PExp₁]. The subsequent determinations sequentially provide PExp₀₁₂₃[7:0]=Max[PExp₀₁, PExp₂₃], PExp_{01234567[}[7:0]=Max[PExp₀₁₂₃, PExp_{4567]}, and, in the last row, MaxExp[7:0]=Max[PExp₀₁₂₃₄₅₆₇, PExp₈₉₁₀₁₁₁₂₁₃₁₄₁₅]. The comparisons of the MaxExp tree 330 take several cycles, resulting in the wasted latency while the subtractors 313, 321 wait.

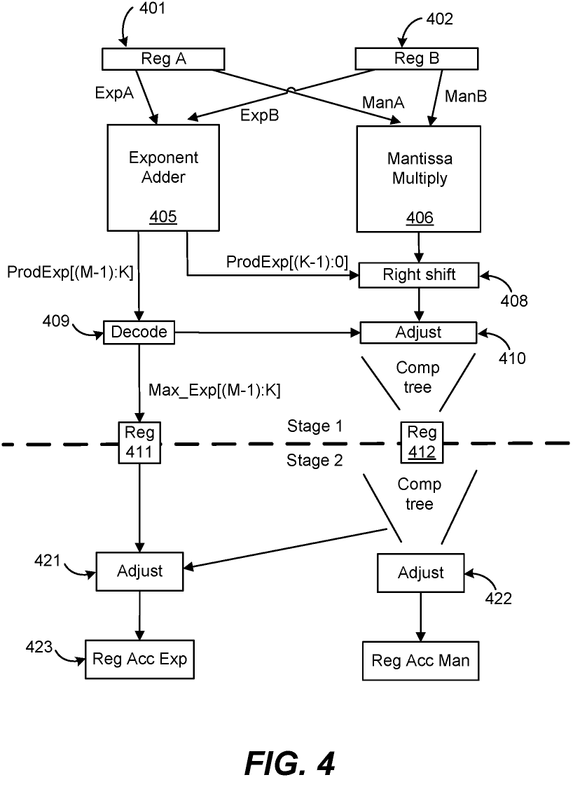

To help avoid or reduce this wasted latency, rather than wait as in FIG. 3 until the full individual shift amounts are calculated (which are dependent upon calculating MaxExp) to right-shift each mantissa product, the embodiments presented in the following instead divides each ProductExpᵢ into two fields, ProductExpHiᵢ and ProductExpLoᵢ. ProductExpLoᵢ is used as a fine-grained shift amount that is used to right-shift each mantissa product as soon as the mantissa product is ready. Only ProductExpHiᵢ participates in the MaxExp calculation. This can speed up the dot-product calculation in two ways. First, right-shifting of the mantissa product can begin as soon as the mantissa products are calculated, without waiting for calculation of MaxExp. Also, the calculation of MaxExp is sped up because MaxExp is calculated only on ProductExpHiᵢ, not the full-width ProductExp. These concepts are illustrated in FIG. 4.

FIG. 4 is a high-level block diagram illustrating the acceleration of the dot-product computation by spitting the product of exponents into a high portion and a low portion. Referring back to FIG. 1B, the computational blocks of FIG. 4, as well as the more detailed figures below, can be considered part of FPU 149 and the input registers and output registers can be considered part of registers 141, although other arrangements, such as a separate coprocessor including the registers or other memory for storing the input and output values, can also use the techniques described here.

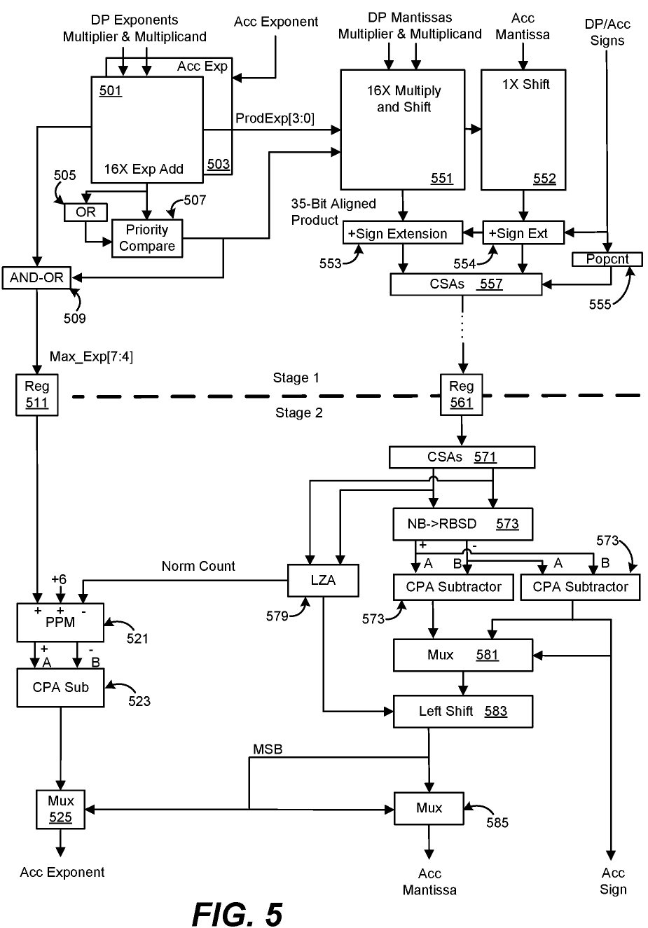

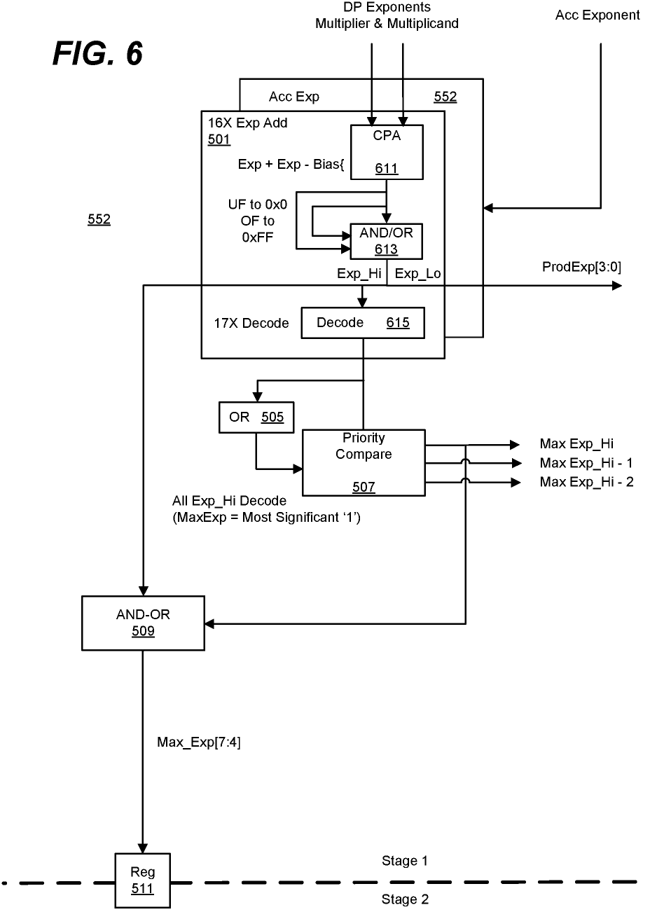

To simplify the initial presentation of FIG. 4, a number of simplifications are made and details left out. For example, underflow/overflow considerations and signs are not taken into account, and previous accumulator factors are also not included. FIG. 5 and its related detail figures will bring in these considerations. In particular, the stage 1 elements of FIG. 5 illustrate embodiments for both a means for computing, in a first computation cycle, the intermediate exponent value from the K most significant bits of the components of the exponent values of the first vector and the second vector, where K is less than M; and a means for computing in the first computation cycle the intermediate mantissa value by right shifting the product of the mantissa values of the corresponding components of the first vector and the second vector based on the (M-K) least significant bits of the components of the exponent values of the first vector and the second vector. More specifically, the stage 1 elements to the left of FIG. 5 relate to components for computing the intermediate exponent value, that can then be stored in the intermediate register 511. The stage 1 elements to the right of FIG. 5 relate to components for computing the intermediate mantissa value, that can then be stored in the intermediate register 561. The stage 2 elements of FIG. 5 illustrate an embodiment of means for determining in a second computational cycle a final exponent value and a final mantissa value of the dot-product of the first floating point vector and the second floating point vector from the intermediate exponent value and intermediate mantissa value stored in the set of intermediate registers. Embodiments for these elements of FIG. 5 are described in more detail FIGS. 6-12. Depending on the embodiment, these elements can include hardware only or a combination of hardware and software (including firmware). For example, logic elements programmed by firmware to perform the functions described herein is one example of elements of the described FPU. A FPU can include a processor, FGA, ASIC, integrated circuit or other type of circuit.

The inputs of the 16 component vectors A and B are respectively received and stored in input registers 401 and 402 or other memory. For example, these vectors can be an input vector for a layer of a neural network and a weight vector for the neural network. The exponents of each vector’s components, ExpA and ExpB, are sent to the exponent adders 405 where they are added component by component. The respective mantissas ManA and ManB are sent to the mantissa multiplier 406 for component-wise multiplication. The product for each of the component’s exponents is then split into lower part and a higher part. In the examples used in the following, the exponents are 8-bit values that are evenly split between the 4 least significant bits and 4 most significant bits. More generally, though, the exponents could be of M bits, which is then split into a ProductExpLo part of the K least significant bits (bits [(K-1):0]) and a ProductExpHi part of the N-K most significant bits (bits [(M-1):K]).

The ProductExpLo part of each component is sent off to the corresponding right shifter 408 on the mantissa side where it is used to right-shift the components’ product values from the mantissa multiplier blocks 406. On the exponent side, only the ProductExpHi part of each component is decoded at block 409. The decoded values can then be used to adjust (where this is described in more detail below) the right shifted products at block 410, with the high portion of the decoded value of MaxExp [(M-1):K] stored in the register 411. On the mantissa side, the adjusted values from block 410 are then sent through a first portion of a compression tree, with the results stored in register 412. These intermediate results for both the exponents and the mantissas can be completed in one cycle and stored in respective intermediate registers 411 and 412.

The placement of the intermediate registers 411 and 412 can vary based upon implementation. The embodiments described here can perform the dot-product calculation in two cycles across a wide variety of clock speeds and technologies; but, to take the example of the intermediate registers 412 and its location within the compression tree, this can be located at various points. The parts of the compression tree that can be completed within a first cycle, for example, can depend on factors such as clock speeds and the size of the logic elements. For a 2 cycle implementation, the intermediate registers 411 and 412 would be located such that stage 1 can be reliably completed in a first cycle and stage 2 reliably completed in a second cycle. Alternate embodiments could break the process into more stages with more corresponding inter-stage registers (such as in the case of a faster clock), or omit the intermediate registers if the process could be reliably completed in a single cycle (such as in the case of a lower relative clock speed).

From the intermediate registers 411 and 412, the accumulated values for the exponent and the mantissa are computed in the second cycle. On the mantissa path, the intermediate mantissa value goes through a second portion of the compression tree. The result from the compression tree can then be used to adjust the mantissa in adjustment block 422 and the exponent in adjustment block 421. More specifically, as explained in more detail below, these adjustments include the removal of leading zeros in block 422 and a corresponding adjustment of the exponent in block 421. The final, adjusted values can then be stored in an output register 423 for the exponent and in an output register 424 for the mantissa.

In the following discussion, the embodiments are described in the context of 16 vector components represented in a bfloat16 1.8.7 format, which has 1 sign bit, 8 exponent bits, and 7 fraction bits and the Acc value is represented in a 1.8.19 format, where there is 1 sign bit, 8 exponent bits, and 19 fraction bits. However, this is only a particular example and the techniques are applicable to any floating-point format. The embodiments in the examples also assumes that ProductExp[7:0]={ProductExpHi[3:0], ProductExpLo[3:0]}; that is, the ProductExpHi and ProductExpLo are of equal widths. Again, however, these techniques are applicable to any combination of widths of ProductExpHi and ProductExpLo which total to ProductExp. Although some comments on denormals (or subnormals) are given below, most of the following discussion assumes that denormals are not supported and that denormals are simply flushed to zero.

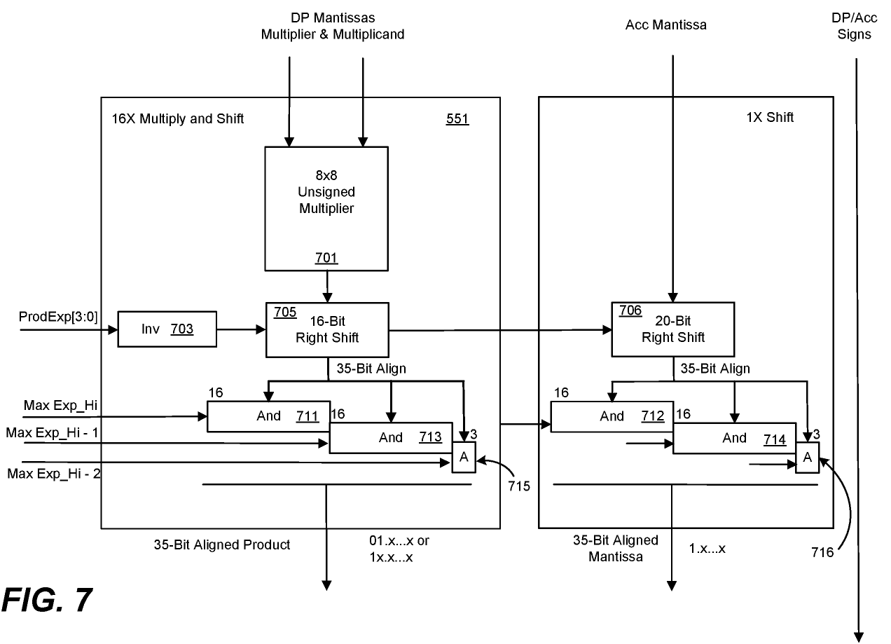

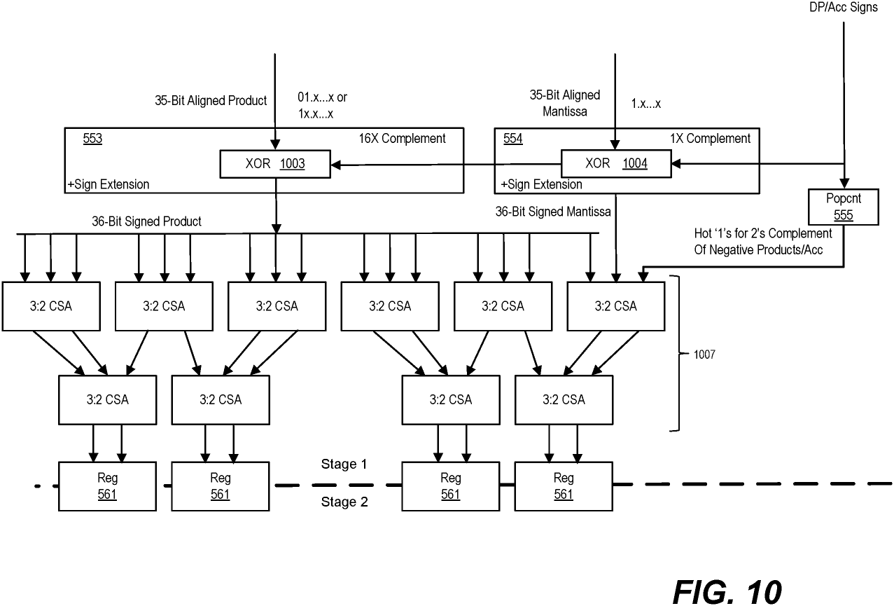

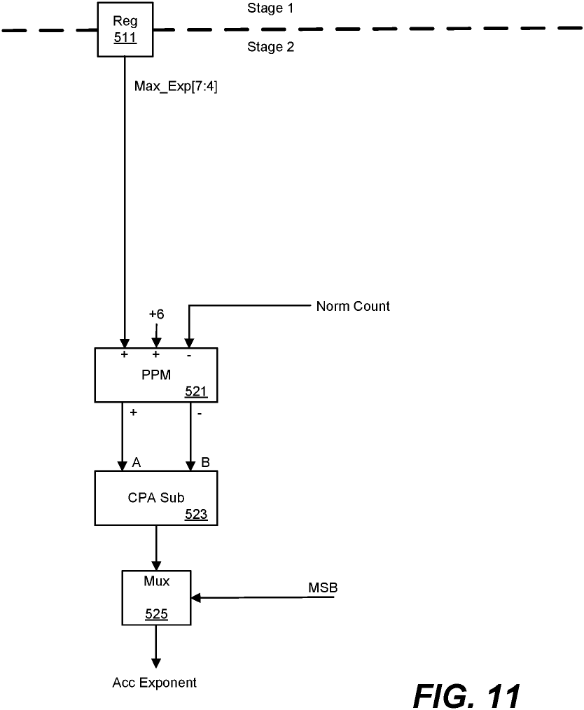

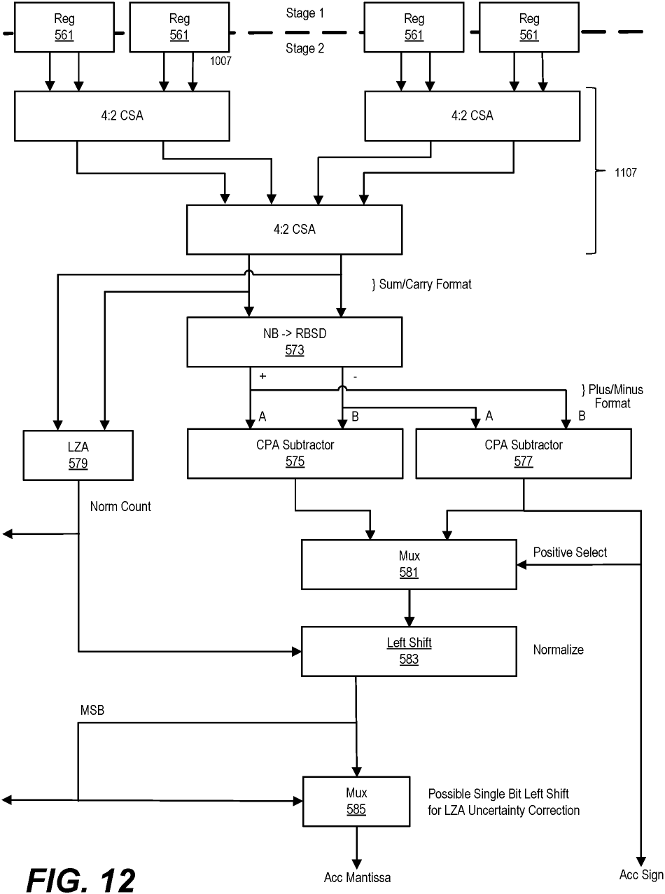

FIG. 5 is a more detailed representation of one embodiment for the data flow paths, but still in a high-level block diagram representation. The various portions of FIG. 5 are presented in more detail in the following figures, but FIG. 5 shows how the several more detailed figures fit together and the discussion will often refer back to FIG. 5 to place these details into the larger context. The components of FIG. 5 can be grouped into a left path and a right path, respectively for determining the exponent value and the mantissa value, and into a first stage and a second staged, where each stage can correspond to one cycle of the microprocessor. The described architecture allows for the dot-product to be computed in two cycles across a wide range of technologies. FIG. 6 provides more detail on the upper left quadrant of FIG. 5; FIGS. 7 and 10 provide more detail on the upper right quadrant of FIG. 5; FIG. 11 provides more detail on the lower left quadrant of FIG. 5; and FIG. 12 provides more detail on the lower right quadrant of FIG. 5.

Providing a brief overview of FIG. 5 before going into the more detailed figures, on the exponent side in stage 1, the exponents of the multiplier and multiplicand for the dot-product (DP) for each component go into a corresponding one of the (16 in this example) exponent adders 501, with exponent of an input accumulator value (such as from a previous multiply and accumulate operation) going into block 503. The ProductExpLo (ProdExp[3:0]) from the Exp Add blocks 501 is provided across to the mantissa path for both the multiply and shift blocks 551 and shift block 552. Output of the Exp Add blocks 501 is also provided to the AND-OR block 509, the OR block 505, and priority compare block 507, where the output of the OR block 505 is also provided to the priority compare block 507, so that the computation of the MaxExp decode vector is made from the bit-wise OR of each of the decoded ProductExpHii and AccExpHi vectors. The output of the priority compare block 507 is provided to the AND-OR block 509 and also to both the multiply and shift blocks 551 and shift block 552. The output of the AND-OR block 509 will be an intermediate value for the maximum product based on the most significant bits (Max_Exp[7:4] in this example) is stored in the register 511 for the intermediate value of the accumulator exponent. These elements are described in more detail with respect to FIG. 6.

From the register 511 for the intermediate value of the accumulator exponent based on the most significant figures of the product of the exponents, stage 2 adjusts the value based on input from the mantissa path. A redundant binary singed digit (RBSD) adder of type “Positive Minus” at block PPM 521, a Carry-Propagate Adder for subtraction at CPA Sub 523, and a multiplexer MUX 525 provide the accumulator exponent output. These elements are described in more detail with respect to FIG. 11.

On the mantissa side, the mantissas of the multiplier and multiplicand for the dot-product (DP) for each component go into a corresponding one of the (16 in this example) multiply and shift block 551, with the mantissa of an input accumulator value (such as from a previous multiply and accumulate operation) going into shift block 552. Multiply and shift block 551 and shift block 552 both receive input from exponent side and respectively provide their output to sign extension blocks 553 and 554. The sign extension blocks 553 and 554 feed into the compression tree of a number of Carry-Save Adders at CSAs block 557, which also receives input from the population counter block popcount 555. The output of the CSAs 557 is an intermediate result for the mantissa value and is saved in the intermediate register 561. These components are described in more detail with respect to FIGS. 7 and 10.

As noted above, the placement (and number) of the intermediate registers 511 and 561, and the division into stage 1 and stage 2, can be implementation dependent. For example, the number of stages of CSAs 557 before the registers 561 and the number of stages of CSAs 571 after the registers 561 may differ from what is shown in more detail in FIGS. 10 and 12, with the intermediate registers 561 coming earlier or later in the compression tree.

In stage 2, the intermediate results for the mantissa value from intermediate register 561 continues through a compression tree of a number of Carry-Save Adders at CSAs block 571. The output of the CSAs block 571 is connected to go to a Leading Zero Anticipator LZA 579, which provides input to the exponent side, and to Redundant Binary Signed Digit block NB->RBSD 573. The redundant binary half-adder circuit NB->RBSD 573 is used to convert redundant normal binary in sum/carry format into redundant binary signed digit format (plus/minus). The output of NB->RBSD 573 is input to the pair of Carry-Propagate Adder (CPA) subtractors 575 and 577. The output of the CPA subtractors 575 and 577 go to a multiplexer MUX 581, along with CPA subtractor providing the sign value of the accumulator value for the dot-product. The output of MUX 581 goes into a left shift register 583, whose output goes in turn to the MUX 585 on the mantissa side to give the accumulator mantissa value and the accumulator MUX 525 on the exponent side to give the accumulator exponent value. On the mantissa side, the output of the CSAs 571 also goes to a Leading Zero Anticipator (LZA) 579 which is used by the left shift block 583 and PPM 521 for adjusting the intermediate mantissa and exponent values.

As noted above, there are two main dataflow paths in this embodiment - one path for exponents and one path for mantissas. FIG. 6 is a more detailed representation of one embodiment for the exponent path in stage 1. Each of the N Exp Add blocks 501 in the exponent path begins by using a Carry-Propagate Adder CPA 611 to add exponents from each dot product to form a dot-product exponent:

$${\text{ProductExp}}_{\text{i}} = \text{Exp} \left({\text{a}}_{\text{i}}\right) + \text{Exp} \left({\text{b}}_{\text{i}}\right) - \text{Bias} .$$

Bias is a constant (set to 0x7f, for example, in the bfloat16 format) and subtraction of this constant does not add appreciable delay to a synthesized adder. For the Acc block 503, a CPA block is not included and the accumulator exponent can used “as-is”, since there is no double counting of the bias. Underflow and overflow may be checked by using a 10-bit adder with zero-extension for equation 5:

$${\text{Underflow is indicated by ProductExp}}_{\text{i}} [ 9 ] = = 1 \text{;}$$

Overflow is indicated by ProductExpᵢ[9] == 0 and ProductExpᵢ[8] == 1 . AND/OR gates 613 are used to set the ProductExpᵢ[7:0] to 8’hff or 8’h00 upon overflow or underflow respectfully. The same is done for AccExp in Acc Exp block 503.

Hi and Lo portions of ProductExp are generated from the output of the AND/OR gates 613 as follows:

$${\text{ProductExpHi}}_{\text{i}} \left[3 : 0\right] = {\text{ProductExp}}_{\text{i}} \left[7 : 4\right] \left(\text{same for AccExp}\right)$$

$${\text{ProductExpLo}}_{\text{i}} \left[3 : 0\right] = {\text{ProductExp}}_{\text{i}} \left[3 : 0\right] \left(\text{same for AccExp}\right)$$

Decodes of each ProductExpHiᵢ[3:0] and AccExpHi[3:0], but not ProductExpLoᵢ[3:0] or AccExpLo[3:0], are created in the decode block 615. The bit-wise OR of all 17 terms in the OR block 505 form a mask which represents a priority-decoded MaxExp[7:4] if scanned from left to right. The Lo parts of the exponent products are instead sent to the perform an early shift of the mantissa products: ProductExpLoᵢ[3:0] = ProductExpᵢ[3:0] values from the Exp Add blocks 501 are sent to the corresponding Multiply and Shift block 551 to right shift the corresponding mantissa product and the AccExpLo[3:0] = AccExp[3:0] from the Acc Exp block 503 is sent to the Acc Shift block 552 to right shift the Acc mantissa value.

Concerning the output from the AND/OR gates 613 (ProductExpHi and ProdExpLo), these are the values after checking for overflow/underflow, meaning (in this example) respectively that if any sum of products greater than 0xff (hexadecimal format for decimal value 255) or less than 0x0 (decimal 0). In IEEE754 format, 0xff in the 8-bit single-precision exponent field and 0x0 in the mantissa field represents “infinity”; and a 0x00 in the exponent field and a 0x0 in the mantissa field represent a value of zero. The exponent value for “normal” single-precision values range from 0xfe (decimal 254) to 0x01 (decimal 1). To take a specific example, suppose the FPU is adding two floating point numbers whose exponent is 0xfe (254). In IEEE-754, the single precision bias is 0x7f (127 decimal). So, to get an unbiased exponent, the CPA block 611 will subtract 127 decimal from each value. Consequently, a biased exponent of 0xfe (254 decimal) represents an unbiased actual exponent of +127 (i.e., 2 to power of 127). As result, (Exp1 = 0xfe) + (Exp2 = 0xfe) - (Bias = 0x7f) = a biased exponent of 0x17d, which overflows as 0x17d is greater than the maximum biased exponent of 0xfe.

More specifically, block 613 not only checks for overflow and underflow, it can force any overflow value to “clamp” to the maximum single-precision exponent value of 0xff and force any underflow value to “clamp” to the minimum single-precision exponent value of 0x00. Using the example above, the exponent value of 0x17d is detected as overflow. The way this works is to sign-extend each exponent and bias to 10 bits (shown here in hexadecimal as 0x0fe + 0xfe - 0x7f = 0x17d). The most significant hexadecimal digit is '0x1' which represents the upper 2 bits in binary of “0b01’. Consequently, the upper 2 bits tested as “01” in binary represents positive overflow. When this condition is true, then a 0xff is logically OR-ed with the exponent result of 0x7d to form 0xff as an overflow value of infinity.

An underflow example with exponents and biases sign-extended to 10 bits would be 0x003 + 0x001 - 0x07f = 0x385. The upper 1 bit (represented by part of the hexadecimal "3" indicates "negative: in 2's complement format.. Consequently, the code tests whether the upper bit = "1" and, if so, then the 8 bit exponent result is AND-ed with 0x00 to form a result of 0x00. An example which neither underflows nor overflows is 0x081 + 0x084 - 0x07f = 0x086. 0x086, which in 10 bit format has the upper bits set to “00”. Since “00” is neither “01” (which represents overflow) nor “1x” (1 followed by “don’t care”), then it neither overflows nor underflows.

The priority compare block 507 is used which takes as inputs MaxExp[7:4] and ProductHiᵢ[3:0] decode vectors and outputs three bits: bit 2 indicates that vector i belongs to the most-significant Hi segment, bit 1 indicates that vector belongs to the most significant segment - 1, and bit 0 indicates that vector i belongs to most-significant - 2 segment. Here, “segment” means that the Producti[15:0] can be placed in one of 16 vectors of 16 bits each, depending upon the value of ProductExpHiᵢ[3:0]. Productᵢ belongs into the most-significant segment (most-significant being the segment represented by MaxExp[7:4]), it is placed into the most- significant segment of the dataflow. Because Productᵢ is shifted, it may spill into the most-significant - 1 segment. Any shifted bits to the right of the most-significant -2 segment are discarded. The Max Exp_Hi, Max Exp_Hi-1, and Max Exp_Hi-2 values are sent to the Multiply and Shift blocks 551 and the Acc Exp block 503. The Max Exp_Hi value from priority compare 507 and the Exp_Hi values from AND/OR blocks 613 are input into the AND-OR block 509 to determine an intermediate maximum exponent value Max_Exp[7:4] that can then be stored in the intermediate exponent value register 511 at the end stage 1. In the embodiments described here, the generation of the value stored in register 511 can be generated in a single cycle across a wide range of technologies.

In the embodiment described above, there is a ProductExp before and after overflow/underflow checking. This embodiment assumes that any product exponent that is greater than the maximum defined exponent (0xfe or decimal 127 for single-precision will automatically cause overflow. In alternate embodiments, temporary overflow in the product exponent and accumulator can be allowed. In this case, the overflow checking (AND/OR block 613) would not be present and a 9-bit exponent could be allowed in the accumulator (Acc exponent in the bottom left of the stage 2 dataflow diagram in FIGS. 5 and 11). In the primary embodiments presented here and described in more detail with respect to FIG. 11, in the stage 2 block PPM 521 the NormCount is subtracted from the MaxExp[7:4] value (also a +6 constant is added), allowing the exponent to come back into the normal exponent range (< 0x0ff) when there is massive cancellation between two large terms. For example, (1.0000001 x 2^257) - (1.0 x 2^257) would produce a final result back in the normal exponent range. In an alternate embodiment allowing temporary overflow, a check for the AccExponent overflow could only be performed at the end of the dataflow and a flag would be set if the FinalExp is > 0x0ff. This alternative allows multiple dot-product16's to be accumulated, then once all the DP16's have been added, the final ACC value (sign, exponent, fraction) is read out and the overflow flag is set if the AccExp > 0x0ff.

FIG. 7 looks at the first part of stage 1 on the mantissa side. For each component of the multiplier A and multiplicand B N-vectors, these are input into the 8x8 unsigned multiplier 701 of the corresponding multiply and shift block 551, with the result going into the 16-bit right shifter 705. The splitting of ProductExpᵢ (and ACCᵢ) into ProductExpHiᵢ and ProductExpLoᵢ segments after the AND/OR block of FIG. 6 allows for the right-shifting of the Productᵢ output of the 8x8 unsigned multiplier 701 immediately upon computation of Productᵢ based upon only ProductExpLoᵢ, which is available before Productᵢ. For the scalar value of the accumulator mantissa, this similarly goes into the 20-bit right shifter 706. (The dot product and accumulator sign input at far right is used in FIG. 10.) The ProdExpLo values from the exponent path go into the corresponding inverter 703 and then on to the 16-right shifter 705 and 20-bit right shifter 706 to perform the initial right shift, providing the 35-bit aligned products. The 35-bit aligned products are then split into a first 16 bits, which go into AND block 711/712, where it is AND-ed with the Max Exp_Hi value; a second 16 bits, which go into AND block 713/714, where it is AND-ed with the Max Exp_Hi-1 value; and the last 3 bits go into AND block 715/716, where it is ANDed with the Max Exp_Hi-2 value. This provides the 35-bit aligned products that will go into a first portion of a compression tree, as illustrated below with respect to FIG. 10. The alignment mechanism of the AND blocks 711-716 steer the right-shifted Productᵢ vector so that it is steered: into a left segment if Productᵢ belongs in MaxExpHi; into a mid-segment if Productᵢ belongs in MaxExpHi - 1; into a right segment if Productᵢ belongs in MaxExpHi - 2; and all zeros in all three segments otherwise.

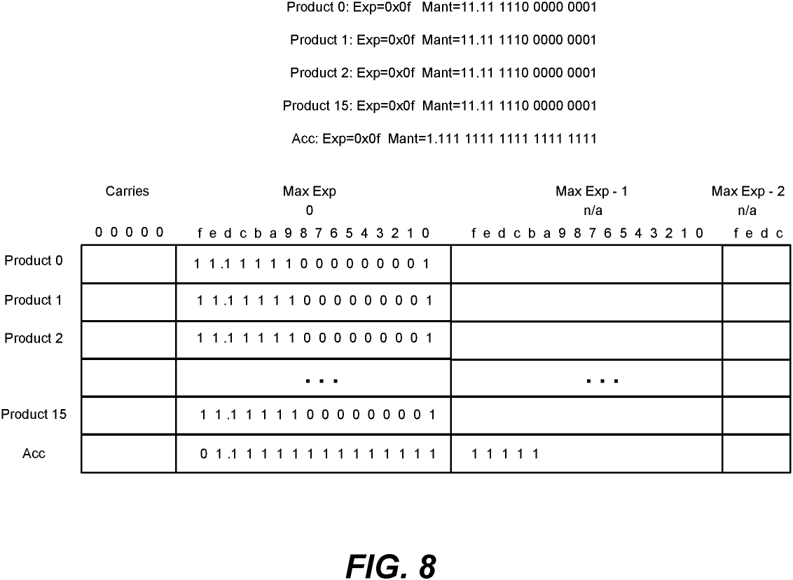

With respect to the AND blocks 711-716, there are two “edge” cases which define the maximum dataflow adder width. The first edge case is the case in which all products and Acc have the same exponent and the shift count is zero (meaning the low nibble of each exponent is 0xf). The maximum product is 0xff * 0xff = 0xfe01. The maximum Acc value is 0xfffff. The sum of these 17 terms is 0x1fe00f which requires 21 bits. Therefore, five bits to the left of the most-significant segment are needed for carries. This is illustrated in FIG. 8.

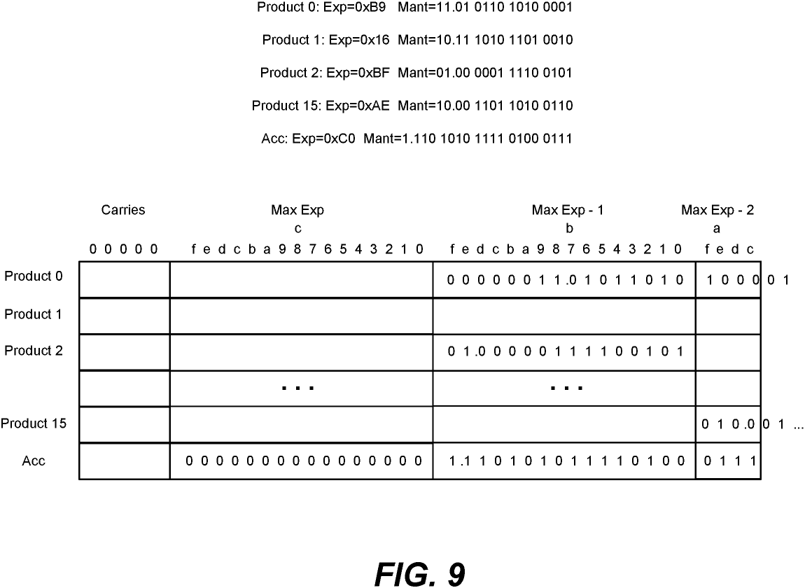

The second ‘edge’ case alignment sets the maximum width of the operands to be added and occurs when the shifted mantissa sets the MaxExp and the shift count of the lower bits is 15 (so the lower nibble of the Mantissa exponent = 0). The MSB of the shifted Mantissa lies in the right-most bit of the MaxExp segment, so the maximum width (exclusive of carries) to be added is 16 bits + 19 bits = 35 bits. Therefore, the relevant widths are:
Carries: 5 bits
Most-Significant Segment: 16 bits
Most-Significant Segment - 1: 16 bits
Most Significant Segment - 2: 4 bits
Sign-Extension: 1 bit
Total Dataflow Adder Width: 42 bits
This second edge case is illustrated in FIG. 9.

The number of MaxExp_Hi, MaxExp_Hi-1, and MaxExpHi-2 values sent from the priority compare block 507 the multiply and shift blocks 551 is implementation dependent, and determined by FIG. 9. FIG. 9 shows that 3 values of MaxExpHi are needed to be sent (MaxExpHi -0, -1, and -2). This is basically a function of segment size (which is itself indicated by how the embodiment segments into MaxExpHi and MaxExpLo) and mantissa width. A minimum of 2 segments are always needed, as a value may always span at least 2 segments.

More generally, the number of bits shifted into MaxExp-1 (and possibly to MaxExp-2 and beyond) is simply the accumulator width. In the example of FIG. 9, the accumulator is aligned so that the MSB (most-significant bit) is always in the MSB of MaxExp-1 segment. Since the accumulator for the example embodiment here is 20 bits and the segment size is 16 bits, then the accumulator spills over into the first 4 bits of MaxExp-2 Segment, so the MaxExp-2 segment is needed. The accumulator width needs to accommodate the number of summed product terms. Since each product is 16 bits in this example and 16 vector components are being summed, the accumulator must be at least 20 bits wide, which is what it is in this example. If, for example, the segments were only 8 bits in width instead of 16 bits in width, and a 20-bit accumulator were still used, this embodiment would need to send MaxExpHi, MaxExpHi-1, MaxExpHi-2, and MaxExpHi-3, since 20 = 8 + 8 + 4. For segments to be 8 bits in width, this would have a split where MaxExpHi[4:0] = MaxExp[7:3] and MaxExpLo[2:0] = MaxExp[2:0], instead of an even split.

FIG. 10 illustrates the lower part of the first stage for the mantissa side of FIG. 5 in more detail. The 35-bit aligned products from the 16 multiply and shift blocks 551 each go into a corresponding sign extension block 553 and the 35-bit aligned product from the shift block 552 goes into the sign extension block 554. The sign extension blocks 553 and 554 include a respective XOR block 1003 and 1004 each configured to receive the corresponding 35-bit aligned product and the corresponding sign input (DP/Acc). The output of each of the sign extension block 553 is the 36-bit signed value for each of the mantissa product and the output of the sign extension block 554 is the 36-bit signed mantissa value for the accumulator value.

Each of the aligned and sign-extended product is then added using a compression tree comprised of 3:2 and 4:2 compressors. The exact configuration of 3:2 and 4:2 compressors can be chosen based upon minimizing the number of XOR levels in the compression tree to have the lowest number of logic levels. This is dependent upon the number of product terms to be added. In the embodiment illustrated in FIG. 10, a first portion 1007 of the compression tree includes two levels of 3:2 Carry-Save Adders (CSA). A population counter circuit PopCount 555 adds the number of negative products, based upon the signs of the operands, and creates a vector of 2's complement “hot-1's” to be added to the product terms. The intermediate result for the mantissa value is stored in the set of registers 561 before being further compressed in stage 2. The number of layers that in the first part of the compression tree 1007 in stage 1 that is done is a first cycle and the number of layers in the stage part of the compression tree depends on the embodiment. Staging flops are placed into the compression tree based on cycle time. It is advantageous for power and area to compress the product terms as much as possible before staging in the registers 561.

FIGS. 11 and 12 respectively illustrate embodiments for stage 2 of the exponent path and the mantissa path. These elements take the intermediate exponent and intermediate mantissa values from the registers 511 and 561 and complete the computation of the accumulator exponent, mantissa, and sign values. On the exponent side, this includes a redundant binary singed digit (RBSD) adder of type “Positive Minus” at block PPM 521, a Carry-Propagate Adder for subtraction at CPA Sub 523, and a multiplexer MUX 525 provide the accumulator exponent output. On the mantissa side, this includes the second first part of the compression tree 1107. The output of NB->RBSD 573 is input to the pair of Carry-Propagate Adder (CPA) subtractors 575 and 577. The output of the CPA subtractors 575 and 577 go to a multiplexer MUX 581, along with CPA subtractor providing the sign value of the accumulator value for the dot-product. The output of MUX 581 goes into a left shift register 583, whose output goes in turn to the MUX 585 on the mantissa side to give the accumulator mantissa value and the accumulator MUX 525 on the exponent side to give the accumulator exponent value. On the mantissa side, the output of the CSAs 571 also goes to a Leading Zero Anticipator (LZA) 579, which is used by the left shift block 583 and PPM 521 for adjusting the intermediate mantissa and exponent values.

In stage 2, compression by the second part of 1107 of the Carry-Save Adder (CSA) tree is completed resulting in a single sum and single carry vector (Sum/Carry format). Since massive cancellation is possible in the sum, the leading zero anticipator (LZA) circuit 579 is used to calculate the number of leading zeros in the sum and is accurate to within [-0, +1] bits. The LZA 579 provides speedup by predicting the number of leading zeros in the sum based upon the sum and carry vectors. The LZA 579 covers the entire 42-bit dataflow width.

The sum could also be negative. If so, the 2's complement of the sum must be taken to product a positive mantissa for the floating point result. Ordinarily, this would require inversion and incrementation. The incrementation operation is operand-width dependent and requires carry-propagation.

A simple method is used to avoid incrementation entirely and make 2's complementation operand-width independent. A redundant-binary half-adder circuit is used to convert ‘normal-binary’ into redundant-binary signed-digit format (RBSD) in block 573. This circuit requires only two levels of logic (NAND/AND) and is carry-free. Once the sum in sum/carry format is converted to RBSD plus/minus format in block 573, 2's complementation is accomplished by calculating B-A in CPA subtractor 577 instead of A-B in CPA subtractor 575, which a simple swap of the plus/minus operands into the subtractor. The selection is made at MUX 581 based upon the output of the CPA subtractor 577, which also provides the Acc sign value. The left shifter 583 normalizes the result based on the Norm count output of LZA 579. Since the sign of the sum is not known in advance, dual subtractors 575 and 577 are used (for speed) to calculate A-B and B-A in parallel, and the positive sum is selected at MUX 585 based upon the most significant bit of the result.

On the exponent side in FIG. 11, the final exponent is calculated as the sum of:

$$\begin{matrix}\text{\{MaxExp[7} \text{.4], 0xF\}} \\ \text{-LZA\_Shift\_Count (Norm Count)} \\ \text{+6} \\ \text{-1 iff final single-bit left shift for LZA uncertainty}\end{matrix}$$

The {MaxExp[7:4], 0xF} represents the bit position of the leading ‘1’ in the most-significant Productᵢ or Acc term. LZA shift count represents the number of leading zeros in the final sum. The +6 is an implementation specific constant, due to the fact that the number of carry bits in this example is 5. More generally, the implementation specific constant is the number of carry bits used, plus one (+1). The final sum can extend into the MaxExp - 1 or MaxExp - 2 segments due to mass-cancellation of the Productᵢ and Acc terms. The final sum can also extend into the ‘Carries’ segment due to the case of effective addition.

There are instances in which the exponent may be negative, such as when there are two small numbers being subtracted: for example, (1.00001 x 2^1)- (1.0 x 2^1 ) gives a resulting answer of (0.00001 x 2^1). The “NormCount” value from LZA 579 in this case would be 5, because it would take a left shift of 5 bits in left shift 583 to have a leading ‘1’ in the result. Consequently, the (normalized) answer would be 1.0 x 2^(1-5) or 1.0 x 2^(-4), which is an exponent that is negative. The handling of negative exponents can depend upon whether denormals (or subnormals) are supported, where a denormal is a floating-point number without a leading “1”.

For embodiments in which the FPU does not support denormals, when a final AccExponent is detected as negative, and the FPU can set the underflow flag (floating-point units have both an ‘underflow’ and an ‘overflow’ flag). If the FPU allows for temporary underflows between successive DP16 operations, then the underflow flag is not yet read until all DP16 operations are completed.

If the FPU does support denormals, the final result is right-shifted by NormCount and the final AccExp is set to zero to indicate a denormal value. The underflow flag is not set for a denormal unless the right shift value is so extreme that the bits ‘fall off the end’ of the shifter, and the shifted value goes to zero.

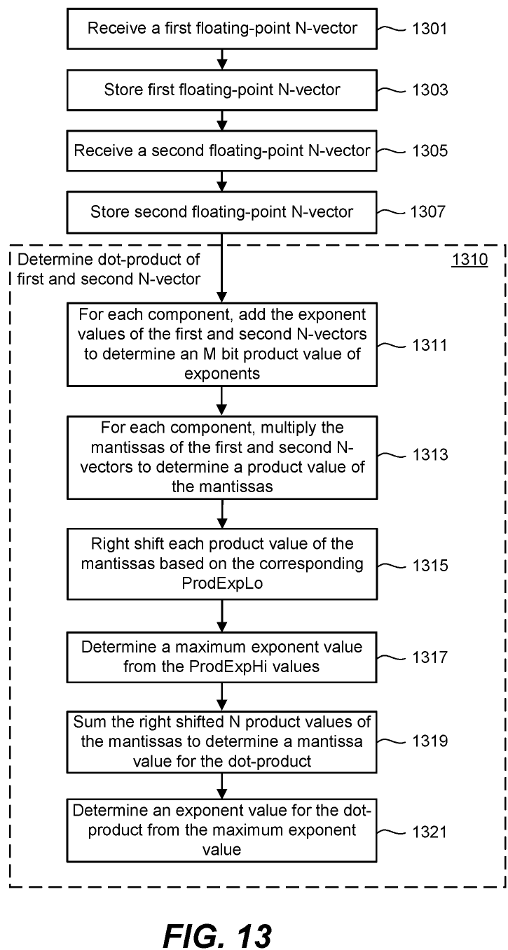

FIG. 13 is a flowchart of one embodiment for calculation a floating-point dot-product performed by a processor using the architecture described above with respect to FIGS. 4-12. At 1301 a first floating-point N-vector is received at a floating-point unit (FPU) of a processor and, at 1303, the first floating-point N-vector can be stored in a memory or a register, such as Reg A 401. At 1305 a second floating-point N-vector is received at the floating-point unit (FPU) and, at 1305, the second floating-point N-vector can be stored in a memory or a register, such as Reg B 402. 1305 and 1307 can occur before, after, or concurrently with 1301 and 1303.

The floating-point dot-product of the first floating-point N-vector and the second floating-point N-vector is determined by the FPU at 1310. Within 1310, 1311 includes adding the exponent value of the first N-vector and the second N-vector to determine an M bit product value of exponents for each of the N components, such as in CPA 611 of the exponent adders 501. At 1313, the mantissas of the first N-vector and the second N-vector are multiplied to determine a product value of the mantissas for each of the N components. 1311 can be performed concurrently, before or after 1313, but will precede 1315. At 1315, each of the N product values of the mantissas are right shifted in blocks 705 by an amount based on a plurality of least significant bits of the corresponding product value of exponents.

At 1317 a maximum exponent value is determined from the N product values of the exponents based on a plurality of most significant bits of the corresponding product value of exponents, where 1317 can be performed before, after, or concurrently with 1315, depending on the embodiment. At 1319 the right shifted N product values of the mantissas are summed to determine a mantissa value for the dot-product, corresponding the portions of FIGS. 7, 10, and 12 subsequent to the right shift block 705. The exponent value for the dot-product is determined from the maximum exponent value at 1321, where 1319 and 1321 can be performed concurrently.

The technical benefits and advantages of the embodiments presented here include low latency compared to traditional dot-product implementations, and particularly so when the number of dot-products to be added is large (≤ dp16). Dot-product operations can often be the clock-speed limiting operation in Al accelerators, GPUs, and CPUs. The low-latency embodied can be used to achieve higher clock speeds or higher clock speeds, that may sometimes be traded off for area as less gate upsizing is required to meet critical path timing in an inherently low-latency design.

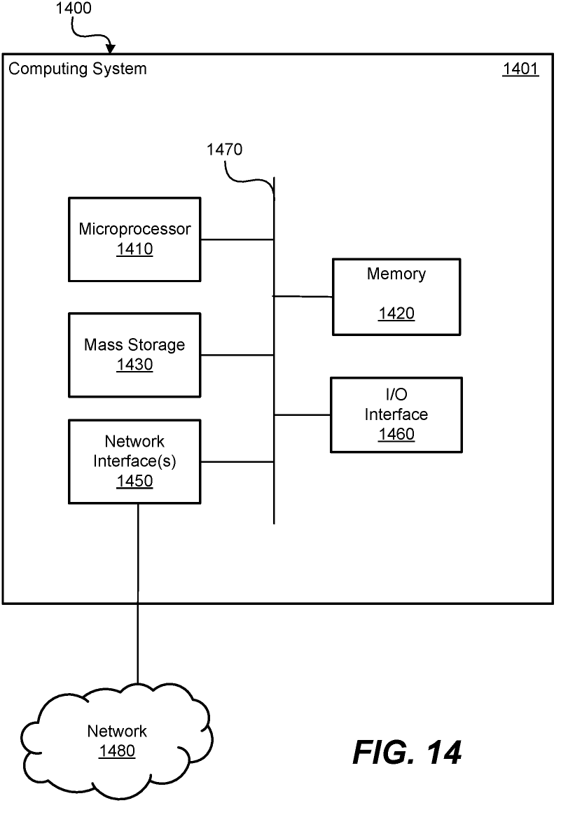

FIG. 14 is a high-level block diagram of a computing system 1400 that can be used to implement various embodiments of the microprocessors described above. In one example, computing system 1400 is a network system 1400. Specific devices may utilize all of the components shown, or only a subset of the components, and levels of integration may vary from device to device. Furthermore, a device may contain multiple instances of a component, such as multiple processing units, processors, memories, transmitters, receivers, etc.

The network system may comprise a computing system 1401 equipped with one or more input/output devices, such as network interfaces, storage interfaces, and the like. The computing system 1401 may include a central processing unit (CPU) 1410, a memory 1420, a mass storage device 1430, and an I/O interface 1460 connected to a bus 1470, where the CPU can include a microprocessor such as described above with respect to FIGS. 1B and 2. The computing system 1401 is configured to connect to various input and output devices (keyboards, displays, etc.) through the I/O interface 1460. The bus 1470 may be one or more of any type of several bus architectures including a memory bus or memory controller, a peripheral bus or the like.

The CPU 1410 may comprise any type of electronic data processor, including the microprocessor 120 of FIG. 1B. The CPU 1410 may be configured to implement any of the schemes described herein with respect to the pipelined operation of FIGS. 2-6, using any one or combination of steps described in the embodiments. The memory 1420 may comprise any type of system memory such as static random access memory (SRAM), dynamic random access memory (DRAM), synchronous DRAM (SDRAM), read-only memory (ROM), a combination thereof, or the like. In an embodiment, the memory 1420 may include ROM for use at boot-up, and DRAM for program and data storage for use while executing programs.

The mass storage device 1430 may comprise any type of storage device configured to store data, programs, and other information and to make the data, programs, and other information accessible via the bus 1470. The mass storage device 1430 may comprise, for example, one or more of a solid-state drive, hard disk drive, a magnetic disk drive, an optical disk drive, or the like.

The computing system 1401 also includes one or more network interfaces 1450, which may comprise wired links, such as an Ethernet cable or the like, and/or wireless links to access nodes or one or more networks 1480. The network interface 1450 allows the computing system 1401 to communicate with remote units via the network 1480. For example, the network interface 1450 may provide wireless communication via one or more transmitters/transmit antennas and one or more receivers/receive antennas. In an embodiment, the computing system 1401 is coupled to a local-area network or a wide-area network for data processing and communications with remote devices, such as other processing units, the Internet, remote storage facilities, or the like. In one embodiment, the network interface 1450 may be used to receive and/or transmit interest packets and/or data packets in an ICN. Herein, the term “network interface” will be understood to include a port.

The components depicted in the computing system of FIG. 14 are those typically found in computing systems suitable for use with the technology described herein, and are intended to represent a broad category of such computer components that are well known in the art. Many different bus configurations, network platforms, and operating systems can be used.

The technology described herein can be implemented using hardware, firmware, software, or a combination of these. Depending on the embodiment, these elements of the embodiments described above can include hardware only or a combination of hardware and software (including firmware). For example, logic elements programmed by firmware to perform the functions described herein is one example of elements of the described FPU. A FPU can include a processor, FGA, ASIC, integrated circuit or other type of circuit. The software used is stored on one or more of the processor readable storage devices described above to program one or more of the processors to perform the functions described herein. The processor readable storage devices can include computer readable media such as volatile and non-volatile media, removable and non-removable media. By way of example, and not limitation, computer readable media may comprise computer readable storage media and communication media. Computer readable storage media may be implemented in any method or technology for storage of information such as computer readable instructions, data structures, program modules or other data. Examples of computer readable storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. A computer readable medium or media does (do) not include propagated, modulated or transitory signals.

Communication media typically embodies computer readable instructions, data structures, program modules or other data in a propagated, modulated or transitory data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as RF and other wireless media. Combinations of any of the above are also included within the scope of computer readable media.

In alternative embodiments, some or all of the software can be replaced by dedicated hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), special purpose computers, etc. For example, some of the elements used to execute the instructions issued in FIG. 2, such as an arithmetic and logic unit (ALU), can use specific hardware elements. In one embodiment, software (stored on a storage device) implementing one or more embodiments is used to program one or more processors. The one or more processors can be in communication with one or more computer readable media/ storage devices, peripherals and/or communication interfaces.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of calculating a floating-point dot-product performed by a processor, comprising:
receiving, by a floating-point unit (FPU) processor, a first floating-point N-vector having N components, each N-vector component of the N components having a first mantissa value and a corresponding exponent value of M bits, where M and N are integers greater than one;
receiving, by the FPU, a second floating-point N-vector having the N components, the each N-vector component of the N components having a second mantissa value and a corresponding exponent value of the M bits;
storing, by the FPU, at least one of the first and second floating-point N-vectors in a memory or a register;
determining, by the FPU, the floating-point dot-product of the first floating-point N-vector and the second floating-point N-vector, by:
adding the first exponent value of the first N-vector and the second exponent value of the second N-vector to determine an M bit product value of exponents for each of the N components;
multiplying the first mantissa of the first N-vector and the second mantissa of the second N-vector to determine a product value of the mantissas for each of the N components;
right-shifting each of the N product values of the mantissas by an amount based on a plurality of least significant bits of the corresponding product value of exponents, the plurality of least significant bits being less than the M bits;
determining a maximum exponent value from the N product values of the exponents based on a plurality of most significant bits of the corresponding product value of exponents, the plurality of most significant bits being less than the M bits;
summing the right-shifted N product values of the mantissas to determine a mantissa value for the dot-product; and
determining an exponent value for the dot-product from the maximum exponent value.

2. The method of claim 1, wherein determining the maximum exponent value includes decoding the plurality of most significant bits of the corresponding product value of exponents to generate a decoded plurality of most significant bits of the corresponding product value of exponents.

3. The method of claim 2, further comprising:
adjusting the right-shifted N product values of the mantissas based on the decoded plurality of most significant bits of the corresponding product value of exponents prior to summing the right-shifted N product values of the mantissas.

4. The method of claim 2, further comprising determining whether each of the M bit product value of exponents is an overflow/underflow value.

5. The method of claim 2, the exponent values of each of the first N-vector and the second N-vector include a bias, and determining the M bit product value of exponents includes:
subtracting off the bias value when adding, for each of the N components, the exponent value of the first N-vector and the second N-vector.

6. The method of claim 2, wherein determining the exponent value for the dot-product includes receiving a correction factor from summing the right-shifted N product values of the mantissas.

7. The method of claim 2, wherein the plurality of most significant bits are K most significant bits and the plurality of least significant bits are (M-K) least significant bits.

8. The method of claim 1, wherein the first floating-point N-vector is an input vector of a layer of a neural network, the second floating-point N-vector is a weight vector of the layer of the neural network, and the dot-product is an output for the layer of the neural network.

9. The method of claim 8, wherein the input vector of the layer of the neural network is an output of a preceding layer of the neural network.

10. The method of claim 8, wherein the output for the layer of the neural network is an input of a subsequent layer of the neural network.

11. The method of claim 1, further comprising:
storing, by the FPU, in an output register, at least one of the exponent value for the dot-product and the mantissa value for the dot-product.

12. The method of claim 1, wherein determining the floating-point dot-product of the first floating-point N-vector and the second floating-point N-vector further comprises:
subsequent to right-shifting each of the N product values of the mantissas and prior to determining the mantissa value for the dot-product, storing an intermediate result of the mantissa value for the dot-product in an intermediate register for the mantissa value for the dot-product; and
subsequent to determining the maximum exponent value from the N product values of the exponents and prior to determining the exponent value for the dot-product, storing an intermediate value for the exponent value for the dot-product in an intermediate register for the exponent value for the dot-product.

13. A microprocessor, comprising:
a plurality of input registers, each input register being configured to hold a floating-point N-vector having N components, each of the components having a first mantissa value and a corresponding exponent value of M bits, where M and N are integers greater than one; and
a floating-point unit connected to the input registers and configured to compute a dot-product of a first floating-point N-vector and a second floating-point N-vector received from the input registers, the floating-point unit comprising:
an exponent determination path configured to determine an exponent value for the dot-product, including:
a first adder configured to add the first exponent value of the first N-vector and the second exponent value of the second N-vector to determine an M bit product value of exponents for each of the N components;
comparison logic configured to determine a maximum exponent value from the N product values of the exponents based on a plurality of most significant bits of the corresponding product value of exponents, the plurality of most significant bits being less than the M bits; and
a second adder configured to determine an exponent value for the dot-product from the maximum exponent value, and
a mantissa determination path connected to the exponent determination path and configured to determine a mantissa value for the dot-product, including:
a multiplier configured to multiply the mantissa values of the first N-vector and the second N-vector to determine a product value of the mantissas for each of the N components;
a right shifter configured to right-shift each of the N product values of the mantissas by an amount based on a plurality of least significant bits of the corresponding product value of exponents, the plurality of least significant bits being less than the M bits; and
a summing circuit configured to sum the right-shifted N product values of the mantissas to determine a mantissa value for the dot-product.

14. The microprocessor of claim 13, wherein the exponent determination path further includes:
a decoder configured to decode the plurality of most significant bits of the corresponding product value of exponents to generate a decoded plurality of most significant bits of the corresponding product value of exponents.

15. The microprocessor of claim 14, wherein the mantissa determination path is further configured to adjust the right-shifted N product values of the mantissas based on the decoded plurality of most significant bits of the corresponding product value of exponents prior to summing the right-shifted N product values of the mantissas.

16. The microprocessor of claim 13, wherein the exponent determination path further includes:
an overflow/underflow detector connected between the first adder and the comparison logic and configured to determine whether each M bit product value of exponents is an overflow/underflow value.

17. The microprocessor of claim 13, wherein the first floating-point N-vector is an input vector of a layer of a neural network, the second floating-point N-vector is a weight vector of the layer of the neural network, and the dot-product is an output for the layer of the neural network.

18. A microprocessor, comprising:
a first input register configured to hold a first floating-point N-vector having N components each having a mantissa value and a corresponding M-bit exponent value, where M and N are integers greater than one;
a second input register configured to hold a second floating-point N-vector having N components each having a mantissa value and a corresponding M-bit exponent value; and
a floating-point unit connected to the first and second input registers and configured to compute a dot-product of the first floating-point N-vector and the second floating-point N-vector, the floating-point unit comprising:
a set of intermediate registers configured to store an intermediate computation of an M bit exponent value of the dot-product and an intermediate computation of a mantissa value of the dot-product;
a first computational section configured to receive the first floating-point N-vector and the second floating-point N-vector and compute and store the intermediate computation of the mantissa value and the intermediate computation of the exponent value for the dot-product in the intermediate set of registers in a first computational cycle, comprising:
a plurality of N multipliers each configured to determine a product of the mantissa values of corresponding components of the first N-vector and the second N-vector;
a plurality of N first adders each configured to bit-wise add exponents of the components of the exponent values of corresponding components of the first N-vector and the second N-vector,
logic circuitry configured to determine the intermediate computation of the exponent value from the K most significant bits of the components of the exponent values of the first N-vector and the second N-vector; and
a plurality of N right shifters configured to determine the intermediate computation of the mantissa value by right-shifting the product of the mantissa values of the corresponding components of the first N-vector and
the second N-vector based on (M-K) least significant bits of the components of the exponent values of the first N-vector and the second N-vector; and
a second computational section configured to receive the intermediate computation of the mantissa value and the intermediate computation of the exponent value and determine a final exponent value of the dot-product and a final mantissa value of the dot-product in a second computational cycle.

19. The microprocessor of claim 18, wherein the first computational section further comprises:
a first partial sum circuit configured to receive and partially sum the right-shifted products of the mantissa values of the corresponding components of the first N-vector and the second N-vector to determine the intermediate computation of the mantissa value,
and wherein the second computational section further comprises:
a second partial sum circuit configured to receive the intermediate computation of the mantissa value and determine the final mantissa value of the dot-product from the intermediate computation of the mantissa value; and
a second adder configured to receive the intermediate computation of the exponent value and determine the final exponent value of the dot-product from the intermediate computation of the exponent value.

20. The microprocessor of claim 18, wherein the first floating-point N-vector is an input vector of a layer of a neural network, the second floating-point N-vector is a weight vector of the layer of the neural network, and the dot-product is an output for the layer of the neural network.
